(19) United States
(12) Patent Application Publication
(10) Pub. No.: US 2017/0325911 A1
(43) Pub. Date: Nov. 16, 2017

(54) Bonding Guide with Living Hinge Pins

(71) Applicant: American Orthodontics Corporation, Sheboygan, WI (US)

(72) Inventor: Michael Craig Marshall, Sheboygan Falls, WI (US)

(73) Assignee: American Orthodontics Corporation, Sheboygan, WI (US)

(21) Appl. No.: 15/592,970

(22) Filed: May 11, 2017

Related U.S. Application Data
(60) Provisional application No. 62/335,398, filed on May 12, 2016.

(51) Int. Cl. A61C 7/14

(52) U.S. Cl. CPC A61C 7/146

(57) ABSTRACT

A bonding guide for placement of an orthodontic apparatus comprises a tray with a tray surface that is configured to be positioned relative to an occlusal surface of at least one tooth in a dentition of a patient. The bonding guide includes a pin with at least one finger at a free end of the pin. The at least one finger is configured to engage an orthodontic apparatus. A hinge is connected to the pin and moves to position the pin relative to the tray. The pin is movable about the hinge between an open position and a closed position when the pin is in the closed position. The pin defines a predetermined treatment location of an orthodontic apparatus relative to a tooth.

### CROSS-REFERENCE TO RELATED APPLICATION

The present application claims priority of U.S. Provisional Patent Application No. 62/335,398, filed on May 12, 2016, the content of which is hereby incorporated herein by reference in its entirety.

### BACKGROUND

The present disclosure relates to the field of orthodontics. More specifically, the present disclosure relates to bonding guide for use in an indirect bonding method of orthodontic bracket application in which the bracket pins are connected to the tray using a living hinge.

Orthodontic brackets can be bonded to a patient's teeth by an orthodontist either through a direct method in which the orthodontist manually bonds each bracket one at a time to each of the patient's teeth or through an indirect method in which a bonding tray holds and seats orthodontic brackets to the patient's teeth. While the indirect bonding technique offers some alignment verification through the use of the tray, bracket placement through either manual or indirect bonding techniques is ultimately determined by the experience and skill of the orthodontist. Incorrect bracket placement leads to unintended arch wire bending or the need for bracket re-positioning during treatment. These intra-treatment procedures are time-consuming clinically and can lead to prolonged treatment times. Indirect bonding trays that promote access to bonding surfaces and bracket pads during the bonding process can facilitate clean and reliable bonds for the brackets applied to a patient's teeth. Indirect bonding trays can further present challenges in positioning brackets on excessively crowded teeth.

### BRIEF DISCLOSURE

An exemplary embodiment of a bonding guide for placement of an orthodontic apparatus includes a tray. The tray includes a tray surface and the tray is configured to be positioned relative to an occlusal surface of at least one tooth in a dentition of a patient. A pin includes at least one finger at a free end of the pin. The at least one finger is configured to engage an orthodontic apparatus. A hinge is connected to the pin. The pin is movable about the hinge to position the pin relative to the tray. The pin is movable about the hinge between an open position and a closed position. When the pin is in the closed position, the pin defines a predetermined treatment location of an orthodontic apparatus relative to a tooth of the dentition of the patient.

In a further exemplary embodiment, the tray surface is configured to conform to an occlusal surface of at least one tooth in a dentition of a patient. In another exemplary embodiment, the bonding guide further includes path control walls that extend from the tray adjacent the pin. The path control walls restrict movement of the pin between the open position and the closed position to generally movement within a single movement plane. In a still further exemplary embodiments, lock projections extend from the path control walls to engage the pin when the pin is in the closed position.

In an exemplary embodiment of an orthodontic system, the system includes a plurality of orthodontic apparatuses configured to be each secured to a tooth of a plurality of teeth. A bonding guide includes a tray. The tray includes a tray surface configured to conform to occlusal surfaces of a plurality of teeth of a dentition of a patient. A plurality of pins includes at least three pins. Each pin of the plurality of pins includes a finger at a free end of each pin. The finger is configured to engage an orthodontic apparatus of the plurality of orthodontic apparatuses. A plurality of hinges are connected to the plurality of pins. The plurality of pins are movable relative to the tray about the plurality of hinges. The plurality of pins are movable between open positions and closed positions. In in closed positions, each pin defines a predetermined treatment location of a respective orthodontic apparatus relative to a tooth of the dentition of the patient.

### BRIEF DESCRIPTION OF THE DRAWINGS

FIG. 1A is a side view of an exemplary embodiment of a bonding tray.

FIG. 1B is a front view of the bonding tray with pins in two different positions.

FIG. 2A is a side view of an additional exemplary embodiment of a bonding tray.

FIG. 2B is a front view of the bonding tray with pins in two different positions.

FIG. 3A depicts another exemplary embodiment of a bonding tray with a removeable set of pivoting pins.

FIG. 3B depicts the same embodiment of the bonding tray with the pins pivoted to place the brackets.

FIG. 4 depicts an exemplary embodiment of a bonding guide with pivoting pins.

FIG. 5 depicts an exemplary embodiment of a bonding guide with a closing bar that facilitates even pivoting of the pins.

FIG. 6A depicts a still further exemplary embodiment of a bonding tray with a pivoting pin, the pivoting pin configured to locate two brackets.

FIG. 6B depicts the same embodiment in a top-down view, showing the crowding of the two teeth and placement of the brackets thereon.

FIG. 7 is an exemplary embodiment of a method of making an indirect bonding guide.

### DETAILED DISCLOSURE

Indirect bonding guides serve to hold one or more orthodontic brackets in a predetermined position relative to a tooth of a patient, for example while an adhesive cures, the adhesive being between the bracket and the surface of the tooth to which that bracket is to be secured. Indirect boning trays facilitate ease and reliability of accurate bracket placement; however, often the ability to remove the tray after use without damaging the newly placed brackets and cleaning of excess adhesive present challenges. Examples of bonding trays and bonding guides are provided in U.S. Pat. No. 9,402,695 entitled, Individualized Jig For Orthodontic Braces, Assembly Formed By That Jig, A Base And A Bracket, And Its Design Methods; U.S. patent application Ser. No. 14/199,343 entitled Indirect Bonding Tray And Method Of Manufacture Thereof; and U.S. patent application Ser. No. 14/949,132 entitled Indirect Bonding Tray And Method Of Manufacture Thereof, all of which are incorporated by reference herein in their entireties.

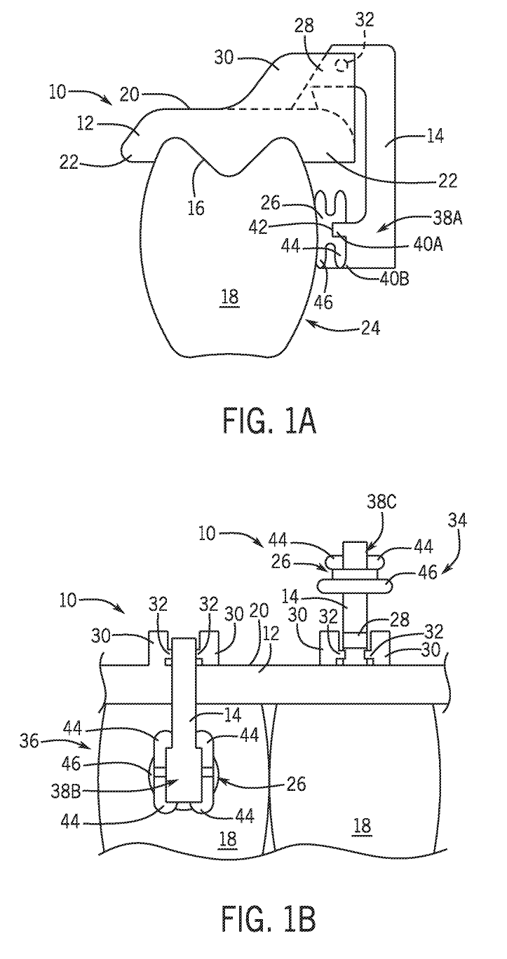

FIGS. 1A and 1B depict a first exemplary embodiment of a bonding guide 10. The bonding guide 10 includes a tray 12 and a pin 14. The tray 12 includes an interior surface 16 that at least partially conforms to an occlusal surface of a tooth 18. An exterior surface 20 of the tray 12 may exemplary be flat and not necessarily conform to the shape of the tooth 18.

The tray 12 further includes ends 22 which in embodiments may extend partially over the occlusal surface of the tooth 18 onto the respective labial and lingual surfaces of the tooth 18. In a still further embodiment, the end 22 of the tray 12 associated with the bonding surface 24 of the tooth (i.e. the surface to which the orthodontic bracket 26 is to be secured) the end 22 leaves the entire bonding surface 24 of the tooth 18 exposed.

The pin 14 is secured to the tray 12 by a flexible hinge 28. In an embodiment, the flexible hinge 28 is constructed of a material different than either the tray 12 and/or pin 14, namely a material with a greater flexibility and/or lower durometer. In still further embodiments, the flexible hinge 28 may be constructed of a reduced diameter or reduced width portion of the pin 14 while in a still further embodiment, both different hinge/tray materials and hinge thickness provides the flexibility of the hinge 28. As will be described in further detail herein, some embodiments, the flexible hinge 28 to have a specific axis of rotation thereby by defining a specific plane within which the pin 14 pivots about the hinge 28. In still other embodiments, the flexible hinge 28 provides a greater degree of freedom, permitting rotation in multiple planes.

The bonding guide 10 depicted in FIGS. 1A and 1B further include pin registration features. The pin registration features of the bonding guide 10 include a path control wall 30 and a lock projection 32. The path control wall 30 engages with the pin 14 or defines a path of rotation for the pin 14 to move from an open position as identified by reference 34 in FIG. 1B and a closed position as identified by reference 36 in FIG. 1B. In the closed position, the bracket is positioned in a predetermined treatment location on the bonding surface 24 of the tooth 18.

The lock projection 32 extends inwardly from the path control wall 30 to engage the pin 14 exemplarily at a hole or detent (not depicted) or other feature in the pin 14 corresponding to the lock projection 32 and configured to facilitate engagement between the lock projection 32 and the pin 14 when the pin 14 is in a position to hold the bracket 26 in the predetermined treatment position. The resilient engagement between the lock projection 32 and the pin 14 enables the pin 14 to be secured into the predetermined treatment position, while later permitting the pin 14 to be removed from engagement with the bracket 26, released from engagement with the lock projection 32 and moved away from the bracket 26 to facilitate clean up of excess adhesive and removal of the tray 12.

It will be recognized that in another embodiment, while not depicted, that the pin 14 may include one or more pin projections which extend from the pin to resiliently engage a hole, detent or other feature on the path control wall 30 to achieve the same results as shown in embodiments above with the lock projection 32 in FIGS. 1A and 1B.

The pin 14 exemplarily holds the bracket 26 that is to be placed at the predetermined treatment position for that tooth 18 and pin 14. The pin 14 holds the bracket 26 in exemplary engagement between a free end 38 of the pin 14. The free end 38 may include one or more fingers 40 configured to engage one or more structures of the bracket 26. As depicted in FIG. 1A, free end 38A may include finger 40A and finger 40B. Finger 40A may be configured to resiliently engage within an arch wire slot 42 of the bracket 26. Finger 40B may be configured to resiliently engage the bracket between one or more pairs of tie wings 44. Additionally, the finger 40B may further extends between the tie wings 44 to engage an outer surface of a pad 46 of the bracket 26, the pad 46 providing the surface of the bracket 26 which is secured to the tooth 18.

As shown in FIG. 1B, free end 38B may be configured to also engage an outer surface of the tie wings 44. In a vestibular bracket placement, the outer surface of the tie wings 44 will be labial, while in a lingual bracket placement, the outer surface of the tie wings 44 will be lingual. The free end 38C exemplarily engages between tie wings 44 while remaining free from engagement with either the pad 46 or outer surfaces of the tie wings 44. It will be recognized that in still further embodiments, the free end 38 may be configured in other manners to releaseably engage an orthodontic bracket. In a still further embodiment, fingers (not depicted) may be provided to engage the mesial and distal ends of a buccal tube to provide for buccal to be placement.

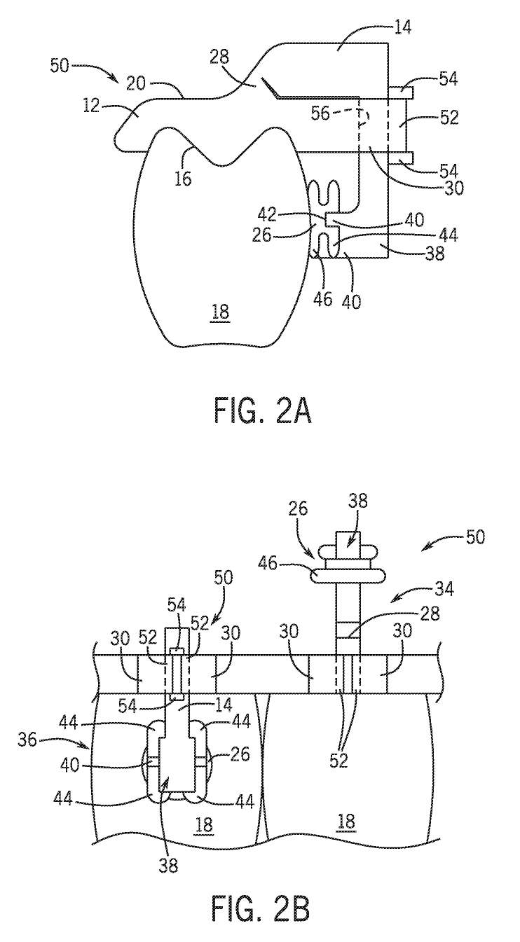

FIGS. 2A and 2B depict an additional exemplary embodiment of a bonding guide 50. It will be recognized that similar reference numerals are used throughout the disclosure to reference similar features across similar embodiments. A person of ordinary skill in the art will recognize that features disclosed in different exemplary embodiments herein may be combined to form further embodiments within the scope of the present disclosure.

The bonding guide 50 similarly includes a pin 14 which is pivotally secured to a tray 12 with a flexible hinge 28. The tray 12 includes path control walls 30, but in the embodiment of the bonding guide 50 depicted in FIGS. 2A and 2B the path control wall 30 extends in the lingual/labial direction from the tray 12. Lock projections 52 extend inward from the path control wall 30 and are configured to engage an exterior surface of the pin 14. In an exemplary embodiment, the path control walls 30 and the lock projections 52 are constructed of a resilient material such that the structures are resiliently deformable to bend outwardly such that the pin 14 can be moved past the lock projections 52 until the pin 14 is in the predetermined treatment position and the path control walls 30 and lock projections 52 return to their normal positions and the lock projections 52 engage the exterior of the pin 14, releasably securing the pin 14 in the predetermined treatment position.

In a still further embodiment, the pin 14 may include one or more pin projections 54. The pin projection 54 may extend outward from the pin 14 and further engage the lock projections 52. While not depicted, the pin projection(s) 54 may be formed by one or more cut-out into the pin 14 within which the lock projections 52 may seat when the pin 54 is in the predetermined treatment position. In this manner, the pin 14 is secured against movement in all three coordinate planes. Engagement of the pin 14 with the path control walls 30 limit movement in the mesial-distal dimension. Engagement of the lock projections 52 (and potentially an end 56 of the tray 12) with the pin 14 limit movement in the labial-lingual dimension. Engagement of the pin projections 54 with the lock projections 52 limit movement of the pin 14 in the occlusal-gingival dimension.

It will be recognized that in other embodiments, more or fewer of the pin projections 54 may be used in embodiments and further pin projections may be alternatively located on the mesial distal sides of the pin 14 such as to engage the path control walls 30 rather than the lock projections 52. In a still further embodiment, a portion of the pin 14 may engage the exterior surface 20 of the tray 12 to provide further registration in the occlusal-gingival dimension.

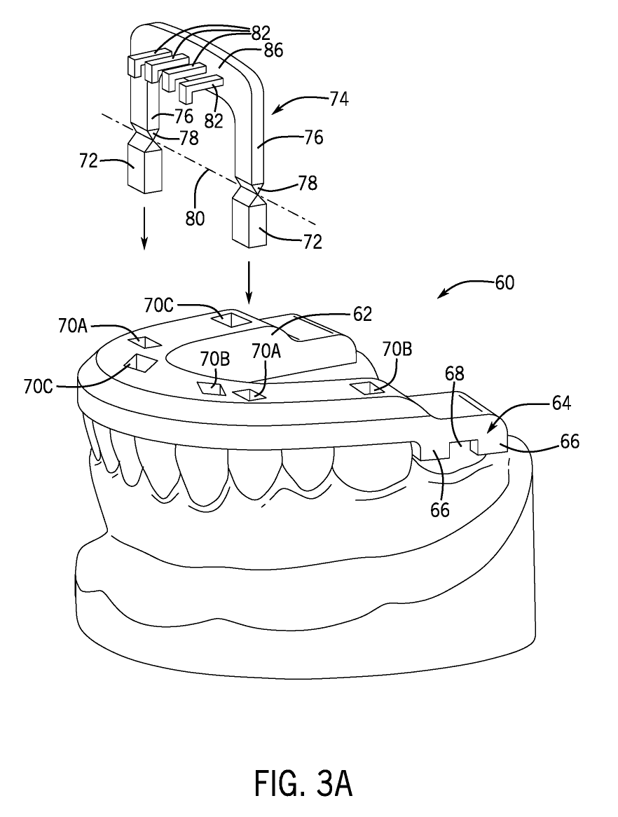

FIGS. 3A and 3B depict an additional exemplary embodiment of a bonding guide 60. The bonding guide 60 includes a tray 62 which is exemplarily constructed to fit some or all of the maxillary or mandibular teeth of a patient. It will be recognized that the tray 62, as depicted in FIGS. 3A and 3B, is exemplarily a hybrid tray in that the tray 62 includes at least one pin as described herein and at least one guide feature 64 which exemplary includes at least one arm 66 and/or a cut-out 68 which defines a position of a bracket or a buccal tube to a predetermined treatment position on a tooth of the patient. In an exemplary embodiment as depicted, such a guide feature 64 may be used for placement of an orthodontic appliance, exemplarily a buccal tube, on a second or third molar of the patient when there is limited access for the pins as described herein. In another example, the guide feature 64 may be used to locate a buccal tube requiring sub-gingival placement of at least a portion of the bonding pad.

The tray 62 further includes a plurality of receiving holes 70. The receiving holes 70 are configured in hole pairs (e.g. 70A, 70B, 70C) and will described in further detail herein and are configured to receive the shanks 72 of a pin assembly 74. The pin assembly 74 is configured with the shanks 72 to be received in the receiving holes 70. In an embodiment, the shanks 72 and receiving holes 70 are keyed or otherwise dimensioned such that only one shank 72 of a plurality of pin assemblies 74 can be received within each of the receiving holes 70.

The shanks 72 are respectively connected to arms 76 of the pin assembly 74 by flexible hinges 78. The flexible hinges 78 share a common pivot axis 80. The corresponding receiving holes 70 maintain this common pivot axis 80 and enable the pin assembly 74 to simultaneously pivot about both of the flexible hinges 78 to move a plurality of pins 82 and associated brackets 84 into the predetermined treatment positions on a plurality of teeth. This is exemplary depicted in FIG. 3B.

In using a bonding guide 62 as exemplarily depicted in FIGS. 3A and 3B, the orthodontist can work to apply brackets to a portion of the patient's dentition at a time. This can facilitate patient comfort and accuracy of the bracket placement by maintaining the common pivot axis 80 for the plurality of pins 82. As all of the pins 82 are connected by a common crossbar 86 between the arms 76 the length of the arms 76 is balanced between accuracy of bracket placement and comfort within the patient's mouth. In use, the orthodontist inserts the shanks 72 of the pin assembly 74 into the corresponding receiving holes (e.g. 70A) and then pivots the arms 76, pins 82, and crossbar 86 about the flexible hinges 78 to position the brackets 84 at the predetermined treatment positions on the teeth of the corresponding portion of the patient's dentition. This is exemplarily depicted in FIG. 3B.

After the brackets 84 have been applied to the respective teeth, the orthodontist disconnects the pins 82 of the pin assembly 74 from the respective brackets 84. The pins 82, crossbar 86 and arms 76 are rotated back about the flexible hinges 78 and the pin assembly 74 is removed from the tray 62 by withdrawing shanks 72 from holes 70A. The orthodontist can repeat the process as necessary with additional pin assemblies which may be similarly constructed, although not depicted. Respective additional pin assemblies may be configured to be removably connected to the tray 62, for example in holes 70B or 70C. These additional pin assemblies may operate in the manner described above to properly locate brackets on teeth in other portions of the patient's dentition, for example along the distal and mesial sides of the arch, as may be represented by holes 70B and 70C. While not depicted, exemplary embodiments may include other numbers and/or shapes of shanks 72 on each pin assembly, including more or fewer. It will be recognized that a corresponding number of receiving holes 70 would be provided in the tray 62 to accommodate the number of shanks 72 used for each pin assembly 74.

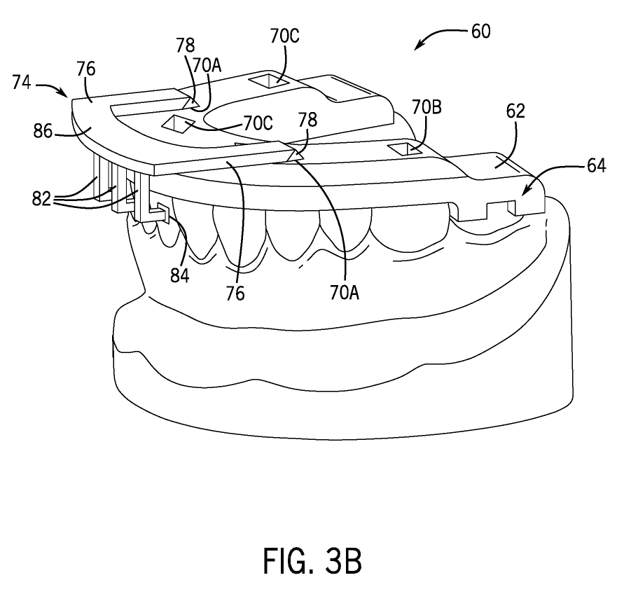

FIG. 4 depicts another exemplary embodiment of a bonding guide 90. The bonding guide 90 includes a tray 92 which is configured to engage some or all of the teeth of an arch of the patient's dentition. In an exemplary embodiment, however, the tray 92 is configured to engage fewer than all of the teeth of an arch of the patient's dentition. Exemplarily, the bonding guide 90 is configured to engage at least three teeth of a patient's dentition and position brackets on these teeth. Flexible hinges 94 secure arms 76 to the tray 92. The flexible hinges 94 are oriented on the tray 92 to have a single pivot axis 80 to promote simultaneous pivoting about the two flexible hinges 94. A plurality of pins 82 are connected to a crossbar 86 between the arms 76. The pins 82, the crossbar 86 and the arms 76 simultaneously pivot about the flexible hinges. The pins 82 are configured to releaseably engage brackets (not depicted) and to move the brackets into the predetermined treatment positions on the patient's teeth.

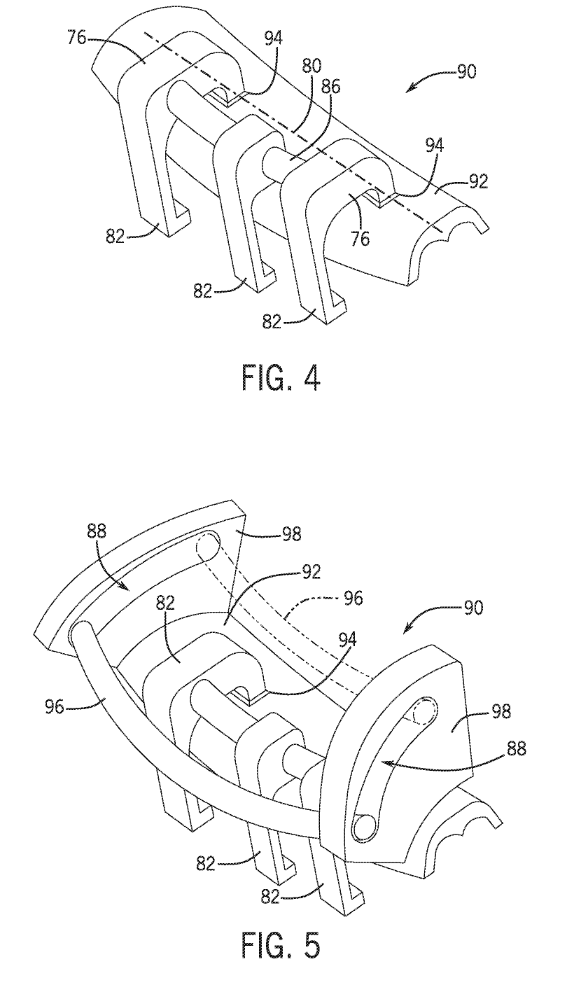

FIG. 5 depicts a similar embodiment in which the bonding guide 90 further includes a pivot bar 96 which extends between a pair of bar guides 98. The bar guides 98 each define a guide aperture 88 therein. The guide apertures 88 may extend partially into the bar guides 98 or, as depicted in FIG. 5, may extend through the bar guides 98. The pivot bar 96 is slidably retained within the guide apertures 88 of the bar guides 98. The pivot bar 96 engages exterior surfaces of the pins 82. The pivot bar 96 is movably secured between the bar guides 98 so as to evenly transfer a pivoting force across all of the pins 82 as the pivot bar 96 is moved such as to simultaneously move the pins 82 from the open position to the closed position. In an embodiment, the orthodontist may engage the pivot bar 96 when it is in the up position as indicated in phantom lines, exemplary with an explorer tool. The orthodontist pulls the pivot bar 96 to the down position as depicted in FIG. 5 and further engages the pins 82 and simultaneously turns the pins 82 about the flexible hinges 94 until the pins 82 are in the predetermined treatment positions and the pivot bar 96 is in the down position. Engagement of the pivot bar 96 against the pins 82 may help to limit placing too much or excessive force against the brackets against the teeth. Furthermore, the pivot bar 96 may help to hold the pins 82 in position while any adhesive used to secure the brackets to teeth is cured.

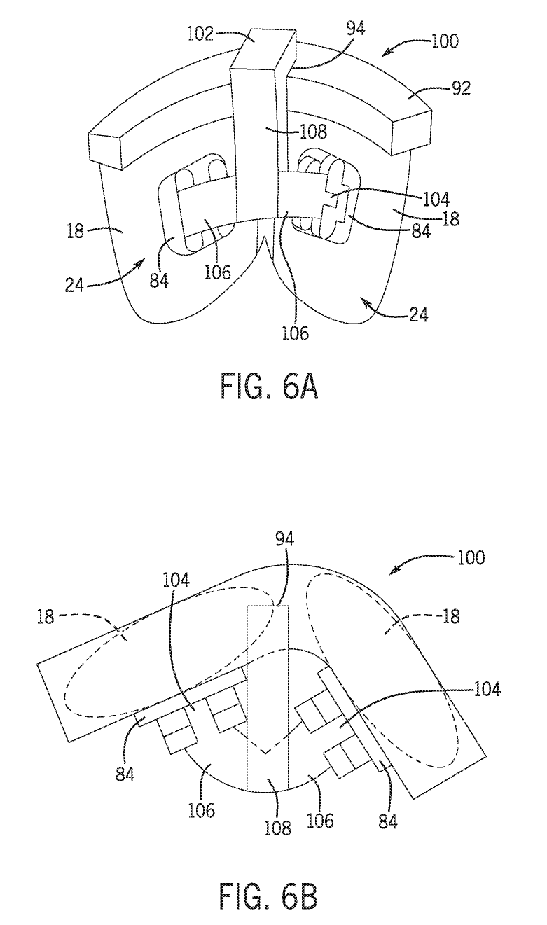

FIGS. 6A and 6B depict a still further exemplary embodiment of a bonding guide 100. The bonding guide 100 includes a tray 92 with a flexible hinge 94 to which a pin 102 is secured. The pin 102 is exemplarily configured to releasably engage multiple brackets 84 with at least one finger 104 of the pin 102. Bracket projections 106 extend from the common arm 108 of the pin 102. At least one finger 104 extends from each of the bracket projections 106. At least two brackets are secured to the pin 102 by these fingers 104.

In view of the exemplary embodiments, the bonding guide 100 may be used when the patient's teeth 18 exhibit excessive crowding and the bonding surfaces 24 of the teeth 18 would otherwise prevent two separate pins from being moved into position to place the bracket 84 at the predetermined treatment positions. The bonding guide 100 exemplarily addresses this problem by enabling simultaneous and coordinated movement and placement of multiple brackets.

It will be recognized that examples of embodiments of bonding guides have been provided in the present description. It will be recognized that these are intended for exemplary purposes and that features of particular examples may be combined with other examples as described herein to arrive at further embodiments within the scope of the present disclosure while not specifically depicted.

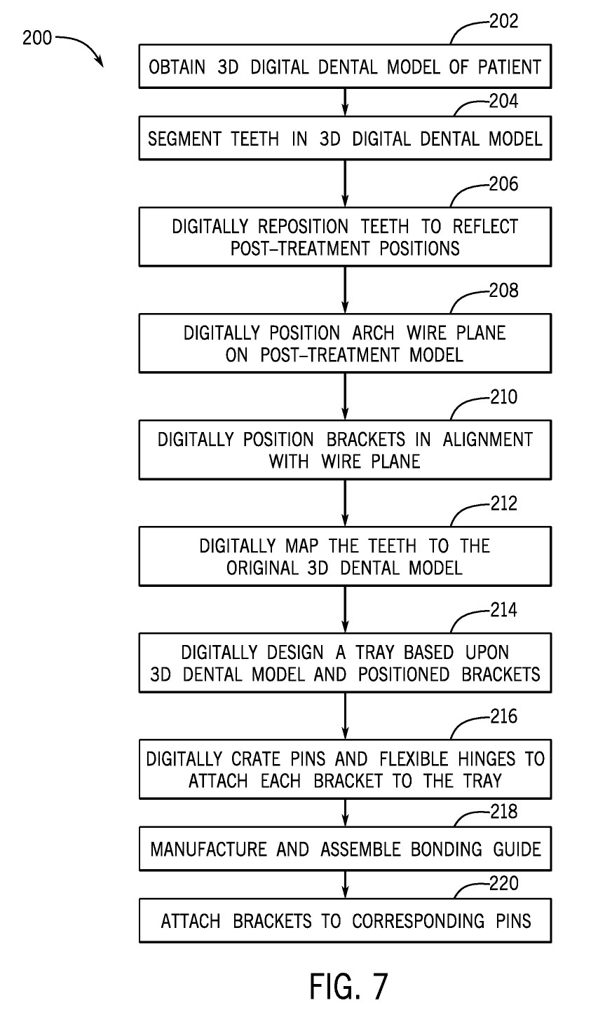

FIG. 7 is a flow chart that depicts an embodiment of a method 200 of manufacturing a bonding guide as described herein. It will be recognized that the bonding guide as manufactured in accordance with the method 200 may include, but is not limited to any of the bonding guides as described above and those as would be recognized by a person of ordinary skill in the art in view of the present disclosure. At 202 a three-dimensional digital model of the patient's pre-treatment dentition is obtained. This 3D digital model may be obtained in a variety of ways including, but not limited to: medical imaging techniques such as computed tomography (CT), by creating a plaster cast of the patient's dentition and digitally scanning the cast, or by intraoral scanning.

At 204 the 3-D digital model is manipulated to segment the individual teeth within the 3-D digital model. The separated teeth are digitally repositioned at 206 to reflect the desired post-treatment positions of the patient's teeth. Each of the transformations required to digitally reposition the separated teeth are recorded and saved. This creates both a record of the original pre-treatment dentition and the transformation required by treatment. Once the teeth have been repositioned into the post-treatment positions, then at 208 an arch wire plane is positioned on the post-treatment model created at 206. It is to be noted that in embodiments, the arch wire plane may be curved, exemplarily to reflect curve of Spee, curve of Wilson, or other dentition.

At 210 digital models of brackets and/or tubes are digitally positioned on each of the patient's teeth in alignment with the arch wire plane. It will be recognized that unless otherwise specified, the structures of brackets and tubes may be understood to interchangeably reference orthodontic apparatus secured to or configured to be secured to the dentition of the patient. The brackets and/or tubes are positioned such that a slot in each bracket and/or hole in each tube coincides with the arch wire plane and the orthodontic apparatus touches or nearly touches the appropriate surfaces of the teeth in the post-treatment model. Once the individual relationship between each of the apparatuses and the teeth in the post-treatment model has been established, at 212 the positioned apparatuses are mapped back to the original 3-D digital model of the patient's pre-treatment dentition. This mapping may be carried out by reversing each of the previously recorded and stored transformations to digitally reposition the teeth. In an embodiment as described in further detail herein, the mapping 212 may include mapping the individual teeth along with a portion of the arch wire plane (as located at 208) associated with each tooth.

At 214 a tray is digitally designed around the 3-D digital model of the patient's dentition and the positioned brackets. The tray may be any of the trays as disclosed, and is designed to conform to the appropriate tooth surfaces such that the tray conforms to the dentition while not interfering with the placement of the brackets on the patient's teeth. Exemplarily, the tray may be designed to conform to the occlusal tooth surface. In embodiments, it will be recognized that engagement of the occlusal tooth surface may include some engagement with the lingual and/or labial tooth surfaces, for example the lingual and/or labial surfaces about the occlusal surface. It will be recognized that in embodiments, when the tray conforms to the dentition of the patient, the tray may not engage occlusal surfaces of some teeth due to the position and/or orientation of specific teeth in the patient's pre-treatment dentition. For example, the tray may bridge across a tooth in the patient's dentition without engaging that tooth at all. This may exemplarily occur if a tooth in the pre-treatment dentition is inaccessible due to excessive crowding or exhibits excessive labial or lingual eruption. In embodiments, an arm and aperture associated with the crowded tooth may still be incorporated into the tray to facilitate bracket placement thereon. In other embodiments, the orthodontist may secure a bracket to the tooth intra-treatment, as crowding in relieved.

In embodiments, the tray may further be designed to engage at least a portion of a tooth surface that is opposed to the bracket bonding surface of the tooth. For example, if the brackets are placed on the labial tooth surface, then the tray may be designed to further conform to at least a portion of the opposite lingual tooth surfaces. On the other hand, if the brackets are to be placed lingually, then the tray may be designed to conform to at least a portion of the labial tooth surfaces. It is to be recognized that in further embodiments, a combination of bracket placement and conformation to tooth surfaces of the tray may occur on the same tooth surface in a single tray. Exemplarily a tray may conform to at least a portion of the labial surface of one or more teeth while the tray is also configured as disclosed herein to place a bracket on the labial surface of the same tooth. In a further exemplary embodiment, single tray may be configured for placement of some brackets on labial surfaces of the teeth and other brackets on lingual surfaces of the teeth.

The digital design of the tray may be performed automatedly with the application of standard tray dimensions relative to the 3-D digital model of the patient's dentition. Alternatively, a technician may input one or more boundaries or parameters for the design of the tray or select from one or more basic tray templates and the additional features of the tray can be added automatedly based upon the 3-D digital model and the bracket placements. In an embodiment, the tray may be generally digitally formed by digitally subtracting volume of the teeth from the standardized volume of the standard tray dimensions. In some embodiments, at least a portion of an exterior or occlusal portion of the tray is defined relative to the patient's dentition. In one embodiment, the bonding tray is designed by defining a tray thickness that is consistent across at least portions of the tray. This thickness is extended outwardly from the tooth surfaces of the digital model of the patient's pre-treatment dentition at directions perpendicular to the tooth surface. In one embodiment, the tray thickness is the same thickness as the pads digitally placed on the digital model, while in alternative embodiments, the tray thickness may be greater than or less than the pad thickness. A tray thickness for some or all portions of a tray may be of a sufficient thickness to accommodate one or more of the various connections between the arms and the tray as disclosed herein. In still further embodiments, the tray may extend generally at a predetermined thickness above the occlusal plane of the pre-treatment dentition. As further described herein, portions of the tray may be thicker than others such as to accommodate apertures for respective arms as described in further detail herein.

At 216 the pins and flexible hinges are digitally created to movably attach each bracket to the tray. The pins and flexible hinges may exemplarily be any of the pins and hinges as described. The pins may be individually connected to the tray by individual flexible hinges, or a plurality of pins may be movably secured to the tray by one or more flexible hinges. The pins are designed to move with respect to the tray to place the bracket at the digitally located bracket position. The design and location of the pins and flexible hinges may be performed automatedly by applying predefined algorithms or design relationships that define the size, shape, and/or dimensions of the pins and flexible hinges to the digitally created tray and the bracket placements. The pin and flexible hinge design may be done automatedly or upon a technician selection of a particular pin and flexible hinge design or configuration. The pins and flexible hinges are designed with relationship to the position of the bracket on the tooth and the portion of the tray designed to conform with that tooth. Embodiments of the pins may be designed with fingers that are dimensioned as described with respect to embodiments disclosed herein to fit an arch wire slot or another physical feature of a corresponding bracket. The finger may be dimensioned to provide a friction fit with the bracket or another physical feature of the bracket. In still further embodiments described herein, at least one finger is designed to releasably and/or resiliently hold or pinch the bracket. A same or similar at least one finger may be designed to releasably and/or resiliently hold or pinch a tube. Additionally, the pin design and/or finger design cooperates with the physical features of the bracket to position the bracket at the predetermined torque, tilt, or rotation relative to the tooth.

As described above, one or more features my define the predetermined treatment position of each pin. Registration features such as walls, detent arms, and projections, along with surfaces of the tray itself can be created to define the desired relationship between the tray (which provides registration to the patient's tooth) and the pin to which the bracket is secured. As described above, when two or more flexible hinges are connected, for example by arms and a cross-bar, the flexible hinges may operate on a common pivot axis. Thus the location of the flexible hinges on the tray can further define the ultimate relationship between the pins and the position at which the pin positions an associated bracket. In at least one embodiment, these features by be digitally designed by working backwards from the desired bracket location and the digitally designed tray, to create the pins and flexible hinges that achieve this bracket placement.

At 218 the digitally designed tray, pins, and flexible hinges are manufactured. The manufacture of such a digitally designed tray, pins, and flexible hinges may be done exemplarily using rapid prototyping, 3D printing, or CNC milling techniques. The flexible hinges may be constructed exemplarily of a different material than another portion of the guide, for example, the tray and/or the two or more material may be selected for their secure interconnectability for example during 3D printing. This may include materials having a same base polymer with differing additive components to impart the differing qualities between the different materials. In such embodiments, the tray may be constructed such as to be releasably secured to the patient's dentition by a friction fit between the teeth and the tray while in an alternative embodiment an adhesive or the like may be applied to the interior of the tray to facilitate temporarily securing the guide tray to the patient's teeth. However, it is understood that other manufacturing techniques may be used. In embodiments in which the tray and pins (or pin assembly comprising multiple pins) are not manufactured in a pre-assembled form, the trays and pins may be separately manufactured and then assembled.

In one particular exemplary embodiment, the bonding guide is 3D printed using at least two different materials of different durometers. In such an example, the flexible hinges are constructed of a material that is more flexible and resiliently movable than the material of the pins and/or the trays. The flexible hinges may further be combined with thinning or other shaping enabling flexibility at the hinge location.

In still further exemplary embodiment, the manufacture of the bonding guide may include the use of other manufacturing techniques or two or more manufacturing techniques. In further embodiments, some or all of the bonding guide may be constructed by injection molding or insert injection molding to add inserts of other materials into the molded bonding guide. In one embodiment, a 3D printer or other rapid prototyping solution may be used to make a cast from which a mold is made, or to make a mold itself for use in construction of the guide. In other embodiments, portions of the guide may be constructed using the same or two or more different processes. In an embodiment, one portion, for example one or more pins and/or hinges may be made or constructed, for example by 3D printing, and then in a second process and other portion of the guide printed, secured or otherwise constructed about the first portion, to complete the guide.

At 220 the brackets to be bonded to the patient's teeth are attached to the corresponding pins.

Citations to a number of references are made herein. The cited references are incorporated by reference herein in their entireties. In the event that there is an inconsistency between a definition of a term in the specification as compared to a definition of the term in a cited reference, the term should be interpreted based on the definition in the specification.

In the above description, certain terms have been used for brevity, clarity, and understanding. No unnecessary limitations are to be inferred therefrom beyond the requirement of the prior art because such terms are used for descriptive purposes and are intended to be broadly construed. The different systems and method steps described herein may be used alone or in combination with other systems and methods. It is to be expected that various equivalents, alternatives and modifications are possible within the scope of the appended claims.

The functional block diagrams, operational sequences, and flow diagrams provided in the Figures are representative of exemplary architectures, environments, and methodologies for performing novel aspects of the disclosure. While, for purposes of simplicity of explanation, the methodologies included herein may be in the form of a functional diagram, operational sequence, or flow diagram, and may be described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology can alternatively be represented as a series of interrelated states or events, such as in a state diagram. Moreover, not all acts illustrated in a methodology may be required for a novel implementation.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A bonding guide for placement of an orthodontic apparatus, the bonding guide comprising:
a tray with a tray surface configured to be positioned relative to an occlusal surface of at least one tooth in a dentition of a patient;
a pin with at least one finger at a free end of the pin, the at least one finger configured to engage an orthodontic apparatus; and
a hinge connected to the pin and movable to position the pin relative to the tray, wherein the pin is movable about the hinge between an open position and a closed position, wherein when the pin is in the closed position, the pin defines a predetermined treatment location of an orthodontic apparatus relative to a tooth.

2. The bonding guide of claim 1, wherein the tray surface is configured to conform to an occlusal surface of at least one tooth in a dentition of a patient.

3. The bonding guide of claim 2, wherein the tray extends along at least a portion of a surface of the tooth opposite the predetermined treatment location.

4. The bonding guide of claim 1, wherein the tray comprises a receiving hole, and further comprising a shank connected to the hinge, wherein the shank is removably insertable into the receiving hole to connect the pin to the tray.

5. The bonding guide of claim 1, further comprising a plurality of pins including the pin, wherein each pin of the plurality of pins comprises at least one finger at a free end thereof, the at least one finger each configured to engage an orthodontic apparatus of a plurality of orthodontic apparatuses.

6. The bonding guide of claim 5, further comprising a crossbar connecting each of the plurality of pins, the crossbar further connected to the hinge which is a first hinge, the crossbar further connected to a second hinge.

7. The bonding guide of claim 6, further comprising:
a first shank connected to the first hinge; and
a second shank connected to the second hinge;
wherein the tray further comprises a first receiving hole and a second receiving hole, the first and second receiving holes configured to respectively removably receive the first shank and the second shank to connect the plurality of pins to the tray.

8. The bonding guide of claim 1, wherein the at least one finger is configured to engage an arch wire slot of the orthodontic apparatus.

9. The bonding guide of claim 1, wherein the at least one finger is configured to engage tie wings of the orthodontic apparatus.

10. The bonding guide of claim 1, further comprising path control walls that extend from the tray adjacent the pin, wherein the path control walls restrict movement of the pin between the open position and the closed position to generally movement within a single movement plane.

11. The bonding guide of claim 10 further comprising lock projections, wherein engagement of the path control walls, lock projections, and the pin releasably secure the pin in the closed position.

12. The bonding guide of claim 11, wherein the lock projections extend from the path control walls to engage the pin when the pin is in the closed position.

13. The bonding guide of claim 12, wherein the pin further comprises at least one pin projection that engages at least one of the path control walls or the lock projections to limit movement of the pin when the pin is in the closed position.

14. The bonding guide of claim 1, wherein the pin comprises a first finger configured to engage a first orthodontic apparatus and a second finger configured to engage a second orthodontic apparatus and wherein when the pin is in the closed position, the pin defines a first predetermined treatment location of the first orthodontic apparatus relative to a first tooth and defines a second predetermined treatment location of the second orthodontic apparatus relative to a second tooth.

15. A bonding guide for placement of an orthodontic apparatus, the bonding guide comprising:
a tray with a tray surface configured to conform to an occlusal surfaces of a plurality of teeth of a dentition of a patient;
a plurality of pins comprising at least three pins each pin of the plurality of pins comprising a finger at a free end of each pin, the finger configured to engage an orthodontic apparatus; and
a plurality of hinges connected to the plurality of pins, the plurality of pins movable relative to the tray about the plurality of hinges between open positions and closed positions, wherein in closed positions, each pin defines a predetermined treatment location of an orthodontic apparatus relative to a tooth of the dentition of the patient.

16. The bonding guide of claim 15, wherein the plurality of hinges comprises hinges secured between each pin of the plurality of pins and the tray.

17. The bonding guide of claim 15, further comprising a crossbar connecting each of the plurality of pins, the crossbar further connected to the hinge which is a first hinge, the crossbar further connected to a second hinge.

18. The bonding guide of claim 17, further comprising:
a pair of bar guides that extend from the tray at positions adjacent the plurality of pins and crossbar; and
a pivot bar movably retained between the pair of bar guides and configured to engage the plurality of pins so as to simultaneously move the plurality of pins from the open positions to the closed positions.

19. The bonding guide of claim 15, further comprising:
a first shank connected to the first hinge; and
a second shank connected to the second hinge;
wherein the tray further comprises a first receiving hole and a second receiving hole, the first and second receiving holes configured to respectively removably receive the first shank and the second shank to connect the plurality of pins to the tray.

20. An orthodontic system, the system comprising:
a plurality of orthodontic apparatuses configured to be each secured to a tooth of a plurality of teeth; and
a bonding guide comprising:
a tray with a tray surface configured to conform to an occlusal surfaces of a plurality of teeth of a dentition of a patient;
a plurality of pins comprising at least three pins each pin of the plurality of pins comprising a finger at a free end of each pin, the finger configured to engage an orthodontic apparatus of the plurality of orthodontic apparatuses; and
a plurality of hinges connected to the plurality of pins, the plurality of pins movable relative to the tray about the plurality of hinges between open positions and closed positions, wherein in closed positions, each pin defines a predetermined treatment location of an orthodontic apparatus relative to a tooth of the dentition of the patient.
